(19) United States
(12) Patent Application Publication
(10) Pub. No.: US 2025/0135595 A1
(43) Pub. Date: May 1, 2025

(54) VIBRATION CHARACTERISTIC ESTIMATION SYSTEM IN MACHINE TOOL, MACHINE TOOL, AND VIBRATION CHARACTERISTIC ESTIMATION METHOD

(71) Applicant: OKUMA CORPORATION, Niwa-Gun (JP)

(72) Inventor: Shunsuke FUJIMAKI, Niwa-Gun (JP)

(73) Assignee: OKUMA CORPORATION, Niwa-Gun (JP)

(21) Appl. No.: 18/908,899

(22) Filed: Oct. 8, 2024

(30) Foreign Application Priority Data
Oct. 31, 2023 (JP) 2023-186972

(51) Int. Cl. B23Q 17/12

(52) U.S. Cl. CPC B23Q 17/12

(57) ABSTRACT

A vibration characteristic estimation system in a machine tool for machining by relatively moving a tool and a workpiece includes: a first vibration characteristic acquisition unit that acquires a first vibration characteristic based on an output of a sensor; a machine information acquisition unit that acquires machine information; a gripping tool information acquisition unit that acquires gripping tool information; a machined portion information acquisition unit that acquires at least one of tool information and workpiece information; a compensation factor acquisition unit that acquires a compensation factor based on at least one of the machine information, the gripping tool information, the tool information, and the workpiece information; and a second vibration characteristic estimation unit that estimates a second vibration characteristic by compensating the first vibration characteristic using the compensation factor, the second vibration characteristic being based on an amount of vibration at a machining point when excitation force is applied.

### CROSS REFERENCE TO RELATED APPLICATION

This application claims the benefit of Japanese Patent Application Number 2023-186972 filed on Oct. 31, 2023, the entirety of which is incorporated by reference.

### FIELD OF THE INVENTION

The disclosure relates to a vibration characteristic estimation system for estimating vibration characteristics in a machine tool, the machine tool, and a vibration characteristic estimation method.

### BACKGROUND OF THE INVENTION

In order to perform high-efficiency and high-accuracy cutting work with a machine tool, it is necessary to select appropriate cutting conditions considering the vibration characteristics of a system including the machine tool, tools, and a workpiece. For example, JP 2020-80015 A discloses a vibration characteristic estimation method for estimating the vibration characteristics of a system by using a vibration measurement result in actual machining. In this method, the vibration characteristic is calculated from the measurement result of vibration during machining at a target point such as a tool tip where the vibration characteristic is desired to be estimated. In the disclosure, to measure the vibration, an accelerometer, for example, a sensor, is attached to the tool tip. However, when the above method is performed at actual work sites, a variety of tools are used by each operator depending on a case, and an operator is required to determine the attaching position of the accelerometer to a tool and also required to check whether the attachment condition is appropriate to estimate the vibration characteristic.

Another vibration characteristic estimation method for estimating the vibration characteristics of a system is disclosed in JP 2012-187691 A. In the disclosed method, an accelerometer such as a sensor is attached in advance at a predetermined position on a machine tool. The sensor attached on the predetermined portion measures a natural frequency and obtains a natural vibration characteristics by an analytical value which is an operation value. Then, a desired vibration characteristic is estimated by using compensated analytical value to the natural vibration characteristics. For compensating the analytical value, the difference between the analytical value of the natural frequency of the main spindle system equipped with a reference tool and a measured value is used as a compensation value. Therefore, the vibration characteristic can be estimated at a desired estimation target point where it is difficult to attach a sensor. On the other hand, in a case of a complex system such as a machine tool, a plurality of natural frequencies exist, and the analytical value of each of the plurality of natural frequencies and a measured value are correlated in descending order of frequency. The compensation value corresponding to each of the plurality of natural frequencies is calculated from the correlated analytical value and measured value.

Therefore, in a situation where the tool used and the reference tool are significantly different, the method disclosed in JP 2012-187691 A might cause making a difference in the order of correspondence of the natural frequency and vibration behavior between a reference tool and a tool used. Accordingly, it might not be able to appropriately estimate the natural frequency even by using the compensation value calculated using the reference tool for a system equipped with the tool used.

In view of the above, a vibration characteristic estimation method for estimating a vibration characteristic of an estimation object where it is difficult to attach a sensor with high accuracy by compensating a vibration characteristic estimated at a predetermined position of a machine tool where it is easy to attach a sensor has been desired.

Therefore, the disclosure has been made in consideration of the above-described problems, and an object of the disclosure is to provide a vibration characteristic estimation system in a machine tool, the machine tool, and a vibration characteristic estimation method that can estimate a vibration characteristic at a target point where it is difficult to attach a sensor with high accuracy by compensating a vibration characteristic at a sensor attaching position of the machine tool.

### SUMMARY OF THE INVENTION

In order to achieve the above-described object, a first configuration of this disclosure is a vibration characteristic estimation system in a machine tool for machining by relatively moving a tool and a workpiece. The vibration characteristic estimation system includes a first vibration characteristic acquisition unit, a machine information acquisition unit, a gripping tool information acquisition unit, a machined portion information acquisition unit, a compensation factor storage unit, a compensation factor acquisition unit, and a second vibration characteristic estimation unit. The first vibration characteristic acquisition unit acquires a first vibration characteristic based on an output of a sensor attached to the machine tool when excitation force is applied to a machining point as a contact point between the tool and the workpiece during machining. The machine information acquisition unit acquires machine information including at least one of a name, an axis configuration, and component part information of the machine tool, and attaching position information of the sensor. The gripping tool information acquisition unit acquires gripping tool information including at least one of a name, a dimension, and a material of a gripping tool that grips the tool or the workpiece, and a gripping method of the tool or the workpiece. The machined portion information acquisition unit acquires at least one of tool information and workpiece information. The tool information includes at least one of a name, a dimension, and a material of the tool. The workpiece information includes at least one of a name, a dimension, and a material of the workpiece. The compensation factor storage unit stores a compensation factor representing a proportion between the first vibration characteristic and a second vibration characteristic in association with at least one of the machine information, the gripping tool information, the tool information, and the workpiece information. The second vibration characteristic is based on an amount of vibration at the machining point when excitation force is applied to the machining point. The compensation factor acquisition unit acquires the compensation factor based on at least one of the machine information, the gripping tool information, the tool information, and the workpiece information from the compensation factor storage unit. The second vibration characteristic estimation unit estimates the second vibration characteristic by compensating the first vibration characteristic acquired by the first vibration characteristic acquisition unit using the compensation factor acquired by the compensation factor acquisition unit. The compensation factor is configured as a function based on the machine information and a frequency linked to the machine information. The frequency is obtained from the sensor.

In another aspect of the first configuration of this disclosure, which is in the above-described configuration, the compensation factor includes a constant linked to at least the tool information.

In yet another aspect of the first configuration of this disclosure, which is in the above-described configuration, the compensation factor is a frequency function linked to at least the machine information.

In order to achieve the above-described object, a second configuration of this disclosure is a machine tool including the above-described vibration characteristic estimation system.

In order to achieve the above-described object, a third configuration of this disclosure is a vibration characteristic estimation method in a machine tool for machining by relatively moving a tool and a workpiece. The vibration characteristic estimation method includes: acquiring a first vibration characteristic based on an output of a sensor attached to the machine tool when excitation force is applied to a machining point of the tool or the workpiece as a contact point between the tool and the workpiece during machining; acquiring machine information including at least one of a name, an axis configuration, and component part information of the machine tool, and attaching position information of the sensor; acquiring gripping tool information including at least one of a name, a dimension, and a material of a gripping tool that grips the tool or the workpiece, and a gripping method of the tool or the workpiece; acquiring at least one of tool information and workpiece information which are included in machined portion information, the tool information including at least one of a name, a dimension, and a material of the tool, the workpiece information including at least one of a name, a dimension, and a material of the workpiece; acquiring a compensation factor representing a proportion between the first vibration characteristic and a second vibration characteristic based on at least one of the machine information, the gripping tool information, the tool information, and the workpiece information, the second vibration characteristic being based on an amount of vibration at the machining point when excitation force is applied to the machining point; and estimating the second vibration characteristic by compensating the first vibration characteristic acquired in the acquiring of the first vibration characteristic using the compensation factor acquired in the acquiring of the compensation factor. The compensation factor is configured based on the machine information and a frequency linked to the machine information. The frequency is obtained from the sensor.

According to the disclosure, a vibration characteristic at a desired point in a machine tool where it is difficult to attach a sensor can be estimated with high accuracy by compensating a vibration characteristic at a point where the sensor is easily attachable based on at least one of the machine information, the gripping tool information, and the tool information or the workpiece information.

In addition, even when a compensation factor of a vibration characteristic for an estimation target point has not been acquired, the vibration characteristic at the target point can be estimated using an acquired compensation factor.

### BRIEF DESCRIPTION OF THE DRAWINGS

FIG. 1 is a schematic configuration diagram illustrating a vibration characteristic estimation system in a machine tool.

FIG. 2 is a flowchart illustrating an estimation method of a second vibration characteristic.

FIG. 3 is a graph illustrating an example of measurement of a first vibration characteristic and a second vibration characteristic.

FIG. 4 is a graph illustrating an example of a compensation factor.

FIG. 5 is a comparison between a direct measurement result and an estimation result of the second vibration characteristic.

FIG. 6 is a comparison between a direct measurement result and an estimation result of the second vibration characteristic.

### DETAILED DESCRIPTION OF THE INVENTION

The following describes an embodiment of the disclosure based on the drawings.

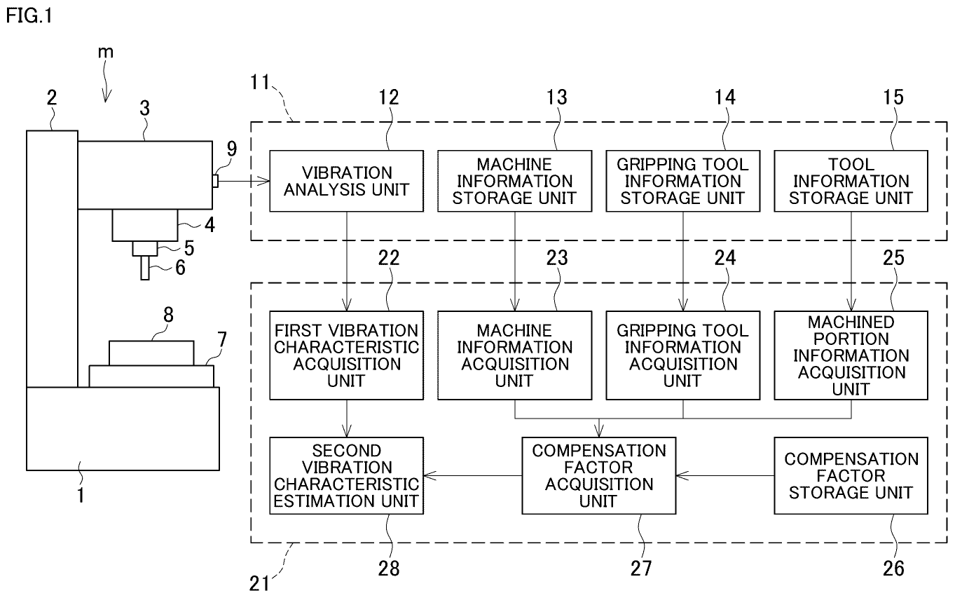

FIG. 1 is a schematic configuration diagram of a machining center, which is an exemplary machine tool.

A main spindle housing 3 of a machining center m includes a main spindle 4 rotatable by a main spindle motor. A tool 6 gripped by a holder 5 is attached to the distal end of the main spindle 4. The main spindle housing 3 as a moving body is movable in a Z-axis direction by a Z-axis motor via a Z-axis ball screw relative to a column 2 attached to a bed 1. An acceleration sensor 9 as a sensor that detects vibration of the machining center m is attached to the main spindle housing 3. A workpiece 8 is secured on a work table 7 as a moving body. The work table 7 is movable on the bed 1 in mutually orthogonal X-axis direction and Y-axis direction. The movement of the work table 7 in the X-axis direction is carried out by an X-axis motor via an X-axis ball screw, and the movement in the Y-axis direction is carried out by a Y-axis motor via a Y-axis ball screw.

An NC device 11 that controls the machining center m includes a machine operation command unit (not illustrated) that controls the main spindle motor and each of feed axis motors based on a program input by an operator and commands the rotation of the tool 6 and the relative movement of the tool 6 and the workpiece 8 to perform cutting work. The NC device 11 includes a CPU and a memory connected to the CPU and realizes the operations by using them.

A vibration characteristic estimation system 21 includes a first vibration characteristic acquisition unit 22, a machine information acquisition unit 23, a gripping tool information acquisition unit 24, and a machined portion information acquisition unit 25. The vibration characteristic estimation system 21 is arranged as a computer included in the NC device 11 or a separate computer and is electrically connected to the machining center m. The first vibration characteristic acquisition unit 22 calculates and acquires a proportion, namely compliance, of the amount of vibration of the main spindle housing 3 to excitation force applied to a machining point. The machining point is a contact point between the tool 6 and the workpiece 8 during machining, that is, a tip of the tool 6 that performs the machining. The proportion of the amount of vibration of the main spindle housing 3 to the excitation force applied to the tip of the tool 6 that performs machining is a first vibration characteristic in the embodiment. In the calculation of the first vibration characteristic, the excitation force applied to the tip of the tool 6 is an output, namely a detected value, of a hammer when the tip of the tool 6 is excited by the hammer with a built-in load sensor, and the amount of vibration of the main spindle housing 3 is an output, namely a detected value, of the acceleration sensor 9. In addition, as disclosed in JP 2020-80015 A, the first vibration characteristic may be calculated by analyzing the vibration during machining detected by the acceleration sensor 9.

The machine information acquisition unit 23 acquires machine information from a machine information storage unit 13, which stores the machine information, included in the NC device 11. In the disclosure, the machine information refers to various kinds of information related to the machining center m for identifying how vibration propagates from the main spindle 4 of the machining center m to the acceleration sensor 9, such as an axis configuration, component part information, a part coupling method, and an attaching position of the acceleration sensor 9, in addition to a machine name.

The gripping tool information acquisition unit 24 acquires gripping tool information from a gripping tool information storage unit 14, which stores the gripping tool information, included in the NC device 11. In the disclosure, the gripping tool information refers to various kinds of information including dimensions of the holder 5, such as a diameter DH and a length LH, a method for gripping the tool 6 by the holder 5, such as a position, a gripping force, and a gripping direction, and a material of the holder 5, in addition to the name of the holder 5.

The machined portion information acquisition unit 25 acquires tool information from a tool information storage unit 15, which stores the tool information, included in the NC device 11. In the disclosure, the tool information refers to various kinds of information including dimensions of the tool 6, such as a diameter DT, an overall length, a blade length, and the number of blades, a projection length LT from the holder 5, and a material of the tool 6, in addition to the name of the tool 6.

The vibration characteristic estimation system 21 further includes a compensation factor storage unit 26, a compensation factor acquisition unit 27, and a second vibration characteristic estimation unit 28. The compensation factor storage unit 26 stores a compensation factor C, which indicates the proportion between the first vibration characteristic and a second vibration characteristic, in association with the machine information, the gripping tool information, and the tool information. The proportion, namely compliance, of the amount of vibration at the tip of the tool 6 to the excitation force applied to the tip of the tool 6 that performs machining is the second vibration characteristic in the embodiment.

The compensation factor acquisition unit 27 acquires the compensation factor C from the compensation factor storage unit 26. The second vibration characteristic estimation unit 28 estimates the second vibration characteristic by compensating the first vibration characteristic using the compensation factor C.

The following describes an estimation method of the second vibration characteristic by the vibration characteristic estimation system of the disclosure.

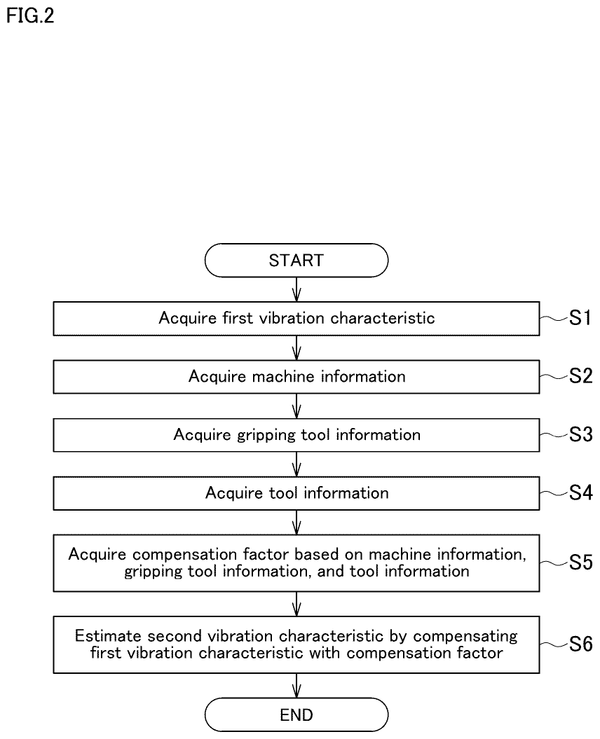

FIG. 2 is a flowchart illustrating the estimation method of the second vibration characteristic.

First, as a first vibration characteristic acquisition step S1, the first vibration characteristic acquisition unit 22 acquires a first vibration characteristic. For the acquisition of the first vibration characteristic, a known method that can calculate the proportion of the amount of vibration of the main spindle housing 3 to the excitation force applied to the tip of the tool 6 that performs machining can be set arbitrarily. In the embodiment, it is assumed that the first vibration characteristic is acquired by analyzing the output information of the acceleration sensor 9 during machining by a vibration analysis unit 12 included in the NC device 11 by reference to the method disclosed in JP 2020-80015 A.

Next, as a machine information acquisition step S2, the machine information acquisition unit 23 acquires machine information from the machine information storage unit 13.

Subsequently, as a gripping tool information acquisition step S3, the gripping tool information acquisition unit 24 acquires gripping tool information from the gripping tool information storage unit 14.

Continuously, as a machined portion information acquisition step S4, the machined portion information acquisition unit 25 acquires tool information from the tool information storage unit 15.

As a compensation factor acquisition step S5, the compensation factor acquisition unit 27 acquires a compensation factor C from the compensation factor storage unit 26 based on the machine information, the gripping tool information, and the tool information acquired in the machine information acquisition step S2, the gripping tool information acquisition step S3, and the machined portion information acquisition step S4.

Then, as a second vibration characteristic estimation step S6, the second vibration characteristic estimation unit 28 estimates a second vibration characteristic at a target point where vibration characteristics are desired to be estimated by compensating the first vibration characteristic acquired by the first vibration characteristic acquisition unit 22 using the compensation factor C acquired by the compensation factor acquisition unit 27.

Here, the details of the compensation factor C used in the vibration characteristic estimation system of the disclosure are described based on examples.

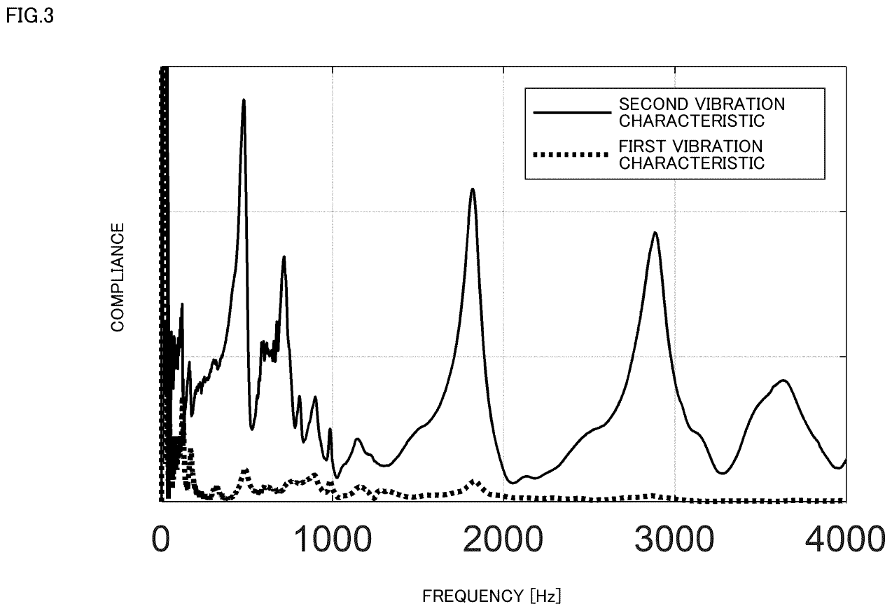

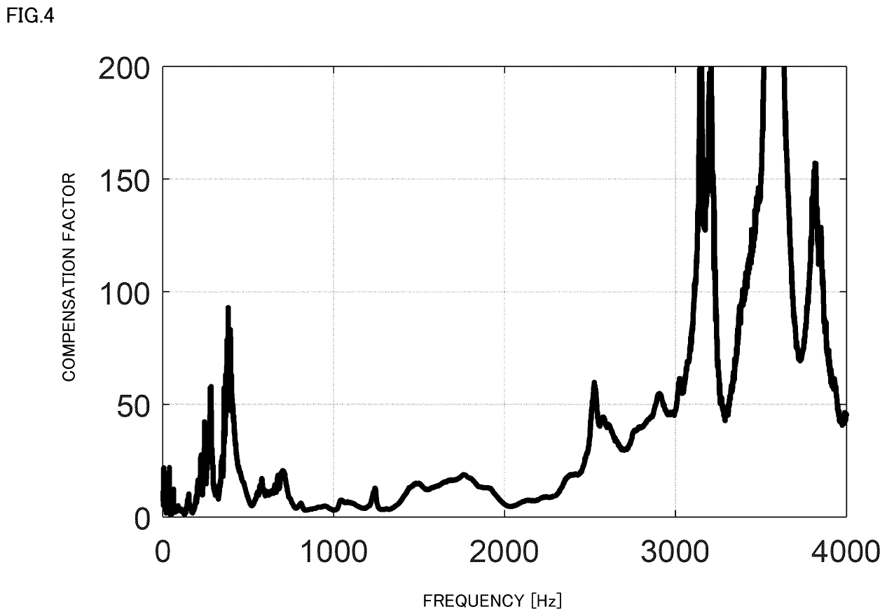

FIG. 3 is a graph illustrating an example of measurement of the first vibration characteristic and the second vibration characteristic. FIG. 4 is a graph illustrating an example of a compensation factor.

As an example, the first vibration characteristic and the second vibration characteristic acquired by a hammering test in a state where a cemented carbide end mill, namely the tool 6, having DT=20 mm is attached to the holder 5 with LT=60 mm in the machining center m having the above-described configuration are illustrated in FIG. 3. The hammering test is performed using a hammer with a built-in load sensor on the machining center m with an acceleration sensor (not illustrated) attached to the tip of the cemented carbide end mill. In the hammering test, the tip of the cemented carbide end mill is excited with the hammer to acquire the output of the load sensor built into the hammer, the output of the acceleration sensor 9 attached to the main spindle housing 3, and the output of the acceleration sensor attached to the tip of the cemented carbide end mill at the time of the excitation. From the respective acquired outputs, the proportion of the output of the acceleration sensor 9 to the hammer output is calculated as the first vibration characteristic, and the proportion of the output of the acceleration sensor attached to the tip of the cemented carbide end mill to the hammer output is calculated as the second vibration characteristic. When the second vibration characteristic is estimated from the first vibration characteristic, the vibration characteristic estimation system 21 preferably acquires the first vibration characteristic by analyzing the vibration during machining such that the estimation can be performed even when an operator does not have specialized techniques or knowledge about vibration. However, the first vibration characteristic for calculating the compensation factor C may be acquired by an expert performing a hammering test at a different opportunity from the estimation of the second vibration characteristic, such as before shipment of the machining center m.

When the first vibration characteristic and the second vibration characteristic acquired by the hammering test are compared, it can be seen that the second vibration characteristic is much larger. This is because both the first vibration characteristic and the second vibration characteristic show ease of vibration, and the tip of the cemented carbide end mill more easily vibrates than the main spindle housing 3.

In addition, when the compensation factor C, which is the proportion between the first vibration characteristic and the second vibration characteristic, is calculated and plotted, it can be seen that the compensation factor C changes with a frequency ƒ as illustrated in FIG. 4. The reason why the compensation factor C changes with the frequency ƒ is that a vibration mode, that is, the state of vibration, varies with the frequency ƒ due to a complex system where the holder 5 and the main spindle 4 intervene between the tip of the tool 6, which is an estimation target point of the vibration characteristic, and the acceleration sensor 9. The variation of the vibration mode causes a difference in how vibration propagates from the tool 6 to the main spindle housing 3. In other words, when the frequency ƒ, a mechanical structure of the machining center m, the holder 5, and the tool 6 are the same respectively, how vibration propagates from the tool 6 to the main spindle housing 3 can be said to be the same.

That is, as long as the frequency ƒ is clear, the second vibration characteristic can be estimated from the first vibration characteristic by using the compensation factor C. Here, in the embodiment, the frequency ƒ of vibration in the main spindle housing 3 can be measured by the acceleration sensor 9. Accordingly, as long as the first vibration characteristic of the system including the main spindle housing 3 and the compensation factor C for an estimation target point can be acquired, the second vibration characteristic at the estimation target point can be estimated from the first vibration characteristic.

On the other hand, as described above, the first vibration characteristic is acquired by the first vibration characteristic acquisition unit 22. In addition, the vibration characteristic estimation system 21 stores the compensation factor C in association with the machine information, the gripping tool information, and the tool information in the compensation factor storage unit 26.

However, when the second vibration characteristic is estimated from the first vibration characteristic using the compensation factor C, the mechanical structure of the machining center m, the holder 5, and the tool 6 must be the same respectively as described above. That is, originally, in order to estimate the second vibration characteristic from the first vibration characteristic using the compensation factor C, it is necessary to acquire a compensation factor C for each of the desired machine information, gripping tool information, and tool information, and then store enormous compensation factors C in the compensation factor storage unit 26.

As an alternative to acquiring and storing enormous compensation factors C as described above, the applicant found that the compensation factor C can be expressed as the product of a compensation factor T and a compensation factor M, as shown in Formula 1. In the embodiment, the compensation factor M is a compensation factor C when the tool 6, which is a reference tool used as a reference for compensation, is attached to the holder 5 and is acquired for each combination of the mechanical structure of the machining center m with the holder 5. The compensation factor T is a proportion between the compensation factor C of the reference tool and a compensation factor C of the tool 6, which is a target tool as an estimation object.

$$c ( f ) = T \times M ( f ) \qquad ( 1 )$$

Since the compensation factor T is a value that depends on the shape of the tool 6, it is linked to the tool information as a constant that does not depend on the frequency. For example, for the tool 6 with a DT of 12 mm, 16 mm, or 20 mm attached to the holder 5 of the machining center m under the condition of an LT of 60 mm, 70 mm, or 80 mm, the compensation factor T calculated from the compensation factor C obtained from a direct measurement value of the hammering test is shown in Table 1. Here, the tool 6 with an LT of 60 mm and a DT of 20 mm is set to the reference tool. As described above, the compensation factor M is equal to the compensation factor C for the tool 6 that is the reference tool. Therefore, for example, the compensation factor T of the tool 6 with LT=60 mm and DT=12 mm is calculated by dividing the compensation factor C of the tool 6 by the compensation factor M for each frequency and obtaining the average value.

The compensation factor M is a value acquired for a plurality of systems which include the holder 5, the main spindle 4, and the main spindle housing 3. Therefore, the compensation factor M is linked to the machine information, the gripping tool information, and information of the reference tool as a function of the frequency ƒ.

Thus, by setting the compensation factor C as a function of the frequency ƒ, also for the tool 6 for which a compensation factor C has not been acquired, the compensation factor C can be calculated from the interpolation or extrapolation of the compensation factor T using an approximation formula based on the acquired compensation factor C and Formula 1. Therefore, even when all the compensation factors C are not always stored in the compensation factor storage unit 26, a compensation factor C is calculated and stored in the compensation factor storage unit 26 based on the acquired frequency, machine information, gripping tool information, and tool information and used in S5 and S6. Accordingly, even when a compensation factor C for an estimation target point of a vibration characteristic has not been acquired, the vibration characteristic at the target point, that is, the second vibration characteristic, can be estimated using an acquired compensation factor C.

| | DT | | |
|---|---|---|---|
| LT | 12 mm | 16 mm | 20 mm |
| 60 mm | 4.7 | 1.8 | 1.0 |
| 70 mm | 5.6 | 2.2 | 1.3 |
| 80 mm | 7.5 | 2.8 | 1.6 |

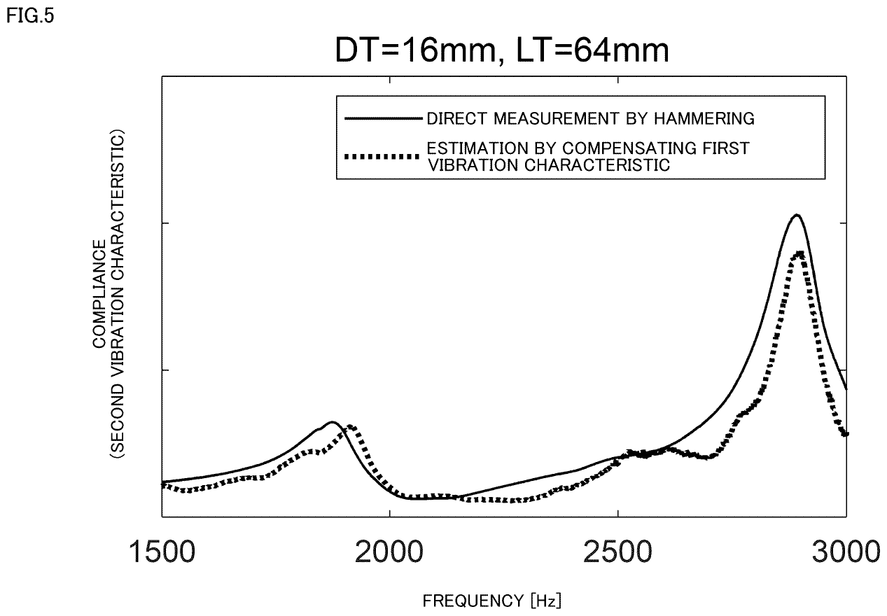

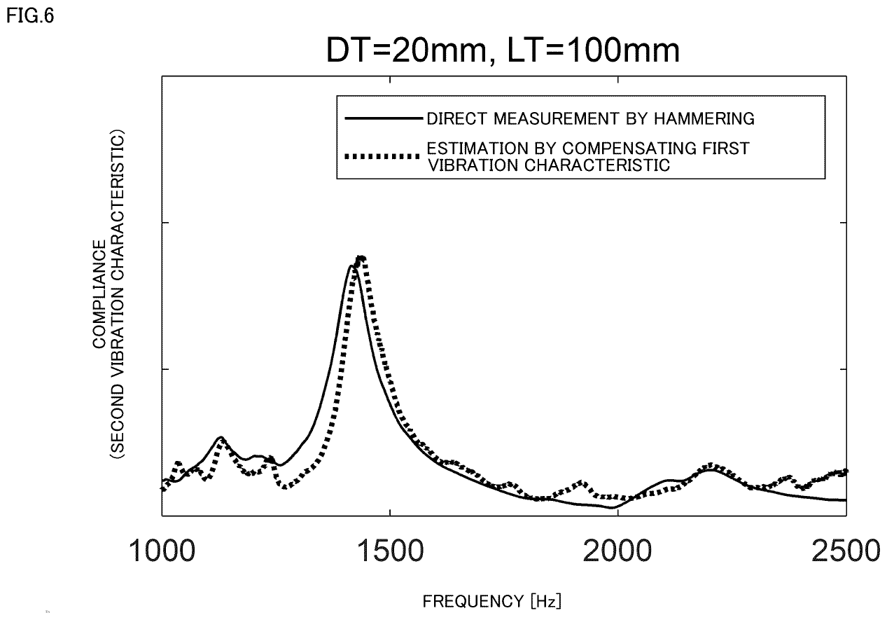

FIG. 5 and FIG. 6 are comparisons between the direct measurement result and the estimation result of the second vibration characteristic.

The accuracy of the second vibration characteristic estimated based on the flowchart in FIG. 2 is examined below. In particular, the case where the compensation factor C for the tip of the tool 6 as the estimation target point of the vibration characteristic had not been acquired was examined.

The estimation accuracy was examined by comparing the direct measurement result with the estimation result when the tool 6 was attached to the holder 5 under the conditions of DT=16 mm and LT=64 mm. The conditions of DT=16 mm and LT=64 mm fall within the range shown in Table 1, namely, the range of the conditions of 60 mm≤LT≤80 mm and 12 mm≤DT≤20 mm. Therefore, an approximation formula for a compensation factor T for LT was obtained from the compensation factors T acquired for the tool 6 with an LT of 60 mm, 70 mm, and 80 mm under the condition of a DT of 16 mm, and the compensation factor C was obtained from the interpolation of the compensation factor T using the approximation formula to estimate the second vibration characteristic by compensating the directly measured first vibration characteristic. As a result, as illustrated in FIG. 5, the second vibration characteristic could be estimated with high accuracy from the first vibration characteristic.

In addition, the estimation accuracy was examined by comparing the direct measurement result with the estimation result when the tool 6 was attached to the holder 5 under the conditions of DT=20 mm and LT=100 mm. The conditions of DT=20 mm and LT=100 mm do not fall within the range shown in Table 1, namely, the range of the conditions of 60 mm≤LT≤80 mm and 12 mm≤DT≤20 mm. Therefore, an approximation formula for a compensation factor T for LT was obtained from the compensation factors T acquired for the tool 6 with an LT of 60 mm, 70 mm, and 80 mm under the condition of a DT of 20 mm, and the compensation factor C was obtained from the extrapolation of the compensation factor T using the approximation formula to estimate the second vibration characteristic by compensating the directly measured first vibration characteristic. As a result, as illustrated in FIG. 6, the second vibration characteristic could be estimated with high accuracy from the first vibration characteristic.

In addition, using a case where the tool 6 is attached to the holder 5 under the conditions of DT=18 mm and LT=75 mm as an example, for the tool 6 under the conditions of both DT and LT not listed in Table 1, a method for obtaining the compensation factor C is described. First, an approximation formula for a compensation factor T for DT is obtained from the compensation factors T acquired for the tool 6 with a DT of 12 mm, 16 mm, and 20 mm under the condition of an LT of 60 mm, and a compensation factor T under the conditions of LT=60 mm and DT=18 mm is obtained using the approximation formula. Similarly, compensation factors T under the conditions of LT=70 mm and DT=18 mm and the conditions of LT=80 mm and DT=18 mm are obtained. Next, an approximation formula for a compensation factor T for LT is obtained from the compensation factors T obtained for the tool 6 with an LT of 60 mm, 70 mm, and 80 mm under the condition of a DT of 18 mm, and the compensation factor C is obtained from the interpolation of the compensation factor T using the approximation formula.

The vibration characteristic estimation system 21 having the above-described configuration includes the first vibration characteristic acquisition unit 22, the machine information acquisition unit 23, the gripping tool information acquisition unit 24, the machined portion information acquisition unit 25, the compensation factor storage unit 26, the compensation factor acquisition unit 27, and the second vibration characteristic estimation unit 28 in the machining center m that performs machining by relatively moving the tool 6 and the workpiece 8. The first vibration characteristic acquisition unit 22 acquires a first vibration characteristic based on an output of the acceleration sensor 9 attached to the main spindle housing 3 of the machining center m when excitation force is applied to the tip of the tool 6 that is a machining point as a contact point between the tool 6 and the workpiece 8 during machining. The machine information acquisition unit 23 acquires machine information including a name, an axis configuration, and component part information of the machining center m, and attaching position information of the acceleration sensor 9. The gripping tool information acquisition unit 24 acquires gripping tool information including a name, a dimension, and a material of the holder 5 that grips the tool 6, and a gripping method of the tool 6. The machined portion information acquisition unit 25 acquires tool information including a name, a dimension, and a material of the tool 6. The compensation factor storage unit 26 stores the compensation factor C representing a proportion between the first vibration characteristic and a second vibration characteristic in association with the machine information, the gripping tool information, and the tool information. The second vibration characteristic is based on an amount of vibration at the tip of the tool 6 when excitation force is applied to the tip of the tool 6. The compensation factor acquisition unit 27 acquires the compensation factor C based on the machine information, the gripping tool information, and the tool information from the compensation factor storage unit 26. The second vibration characteristic estimation unit 28 estimates the second vibration characteristic by compensating the first vibration characteristic acquired by the first vibration characteristic acquisition unit 22 using the compensation factor C acquired by the compensation factor acquisition unit 27. The compensation factor C is configured based on the machine information and a frequency linked to the machine information, and the frequency is obtained from the main spindle housing 3.

Accordingly, in the machining center m, the second vibration characteristic, which is a vibration characteristic at the tip of the tool 6 where the acceleration sensor 9 is difficult to attach, can be estimated with high accuracy by compensating the first vibration characteristic, which is a vibration characteristic of the main spindle housing 3 that is a point where the acceleration sensor 9 is easily attachable, based on the machine information, the gripping tool information, and the tool information.

In addition, the compensation factor C having the above-described configuration includes a constant linked to the tool information and is a frequency function linked to the machine information.

Accordingly, even when a compensation factor C for the tip of the tool 6 that is an estimation target point of a vibration characteristic has not been acquired, the second vibration characteristic that is the vibration characteristic at the tip of the tool 6 can be estimated using an acquired compensation factor C.

While the disclosure is described based on an illustrated example above, the technical scope of the disclosure is not limited thereto. The configuration related to the vibration characteristic estimation system in a machine tool, the machine tool, and the vibration characteristic estimation method of the disclosure is not limited to the aspect described in the above embodiment and may be appropriately changed as necessary without departing from the spirit of the disclosure.

For example, the first vibration characteristic and the second vibration characteristic are not limited to compliance, but may be different values, such as mobility or inertance. Furthermore, as long as calculation is possible by compensating the first vibration characteristic by a compensation factor, the first vibration characteristic and the second vibration characteristic may be a combination of values of another kind.

Moreover, the sensor that becomes a source of an output used to acquire the first vibration characteristic is not limited to an acceleration sensor, and for example, may be encoders included in a main spindle motor, an X-axis motor, a Y-axis motor, and a Z-axis motor. In this case, the compensation factor M is acquired for components up to the attaching positions of the encoders.

In the embodiment, while the machine information acquisition unit acquires machine information from an NC device, it may acquire the machine information from a device other than the NC device, such as an external information device, or may have the machine information directly input by, for example, an input unit separately disposed. The same applies to the gripping tool information acquisition unit and the machined portion information acquisition unit.

Furthermore, the components included in the compensation factor T and the compensation factor M are not limited to the combinations of the tool information, the machine information, and the gripping tool information. For example, the compensation factor M may be set to a compensation factor C when the combination of the tool 6 as a reference tool with the holder 5 is attached to the main spindle 4, the compensation factor T may be set to the proportion between the compensation factor C of the reference tool holder and a compensation factor C of the combination of the tool 6 as an estimation object and the holder 5, and the gripping tool information may also be linked to the compensation factor T. Similarly to the embodiment, by approximating the compensation factor T by the size of the tool 6 with DT and LT and the size of the holder 5 with DH and LH, estimation becomes possible for the size of the holder 5 with DH′ and LH′ for which the compensation factor C has not been acquired.

Moreover, in the embodiment, the estimation target point of a vibration characteristic is set to a tool tip, and the second vibration characteristic is set to the compliance of the tool tip. However, estimation may be performed by setting the estimation target point of the vibration characteristic to a workpiece and setting the second vibration characteristic to the compliance of the workpiece. In that case, the acceleration sensor 9 is attached to the work table 7 to which the workpiece 8 is mounted, and the frequency is obtained from the work table 7. Then, in S3, the gripping tool information acquisition unit 24 acquires workpiece gripping tool information including a workpiece gripping tool name, a workpiece gripping tool dimension, a workpiece gripping method, such as a position, a gripping force, and a gripping direction, and a workpiece gripping tool material from the gripping tool information storage unit 14. In S4, the machined portion information acquisition unit 25 acquires workpiece information including a workpiece name, a workpiece dimension, and a workpiece material from a workpiece information storage unit, which stores the workpiece information, included in the NC device 11. Further, in S5, the compensation factor acquisition unit 27 acquires the compensation factor C from the compensation factor storage unit 26 based on at least one of the machine information, the workpiece gripping tool information, and the workpiece information.

In addition, the object to which the disclosure is adapted is not limited to a machining center as long as it is a machine tool that performs machining by relatively moving a tool and a workpiece. For example, the disclosure can be adapted to a multitasking machine, and in that case, an acceleration sensor may be attached to a main spindle housing of a workpiece main spindle that rotates the workpiece to estimate the compliance of the workpiece. Moreover, the disclosure can also be adapted to a lathe, and in that case, an acceleration sensor may be attached to a tool post to which a non-rotating tool is attached to estimate the compliance of the tool. The frequency is obtained from the tool post in this case.

Here, when the disclosure applies to the multitasking machine and the lathe, the first vibration characteristic and the second vibration characteristic are set to compliance. However, as described above, the first vibration characteristic and the second vibration characteristic are not limited to compliance.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A vibration characteristic estimation system in a machine tool for machining by relatively moving a tool and a workpiece, comprising:
a first vibration characteristic acquisition unit that acquires a first vibration characteristic based on an output of a sensor attached to the machine tool when excitation force is applied to a machining point as a contact point between the tool and the workpiece during machining;
a machine information acquisition unit that acquires machine information including at least one of a name, an axis configuration, and component part information of the machine tool, and attaching position information of the sensor;
a gripping tool information acquisition unit that acquires gripping tool information including at least one of a name, a dimension, and a material of a gripping tool that grips the tool or the workpiece, and a gripping method of the tool or the workpiece;
a machined portion information acquisition unit that acquires at least one of tool information and workpiece information, the tool information including at least one of a name, a dimension, and a material of the tool, the workpiece information including at least one of a name, a dimension, and a material of the workpiece;
a compensation factor storage unit that stores a compensation factor representing a proportion between the first vibration characteristic and a second vibration characteristic in association with at least one of the machine information, the gripping tool information, the tool information, and the workpiece information, the second vibration characteristic being based on an amount of vibration at the machining point when excitation force is applied to the machining point;
a compensation factor acquisition unit that acquires the compensation factor based on at least one of the machine information, the gripping tool information, the tool information, and the workpiece information from the compensation factor storage unit; and
a second vibration characteristic estimation unit that estimates the second vibration characteristic by compensating the first vibration characteristic acquired by the first vibration characteristic acquisition unit using the compensation factor acquired by the compensation factor acquisition unit, wherein
the compensation factor is configured as a function based on the machine information and a frequency linked to the machine information, and
the frequency is obtained from the sensor.

2. The vibration characteristic estimation system in a machine tool according to claim 1, wherein
the compensation factor includes a constant linked to at least the tool information.

3. The vibration characteristic estimation system in a machine tool according to claim 1, wherein
the compensation factor is a frequency function linked to at least the machine information.

4. A machine tool comprising the vibration characteristic estimation system according to claim 1.

5. A vibration characteristic estimation method in a machine tool for machining by relatively moving a tool and a workpiece, comprising:
acquiring a first vibration characteristic based on an output of a sensor attached to the machine tool when excitation force is applied to a machining point of the tool or the workpiece as a contact point between the tool and the workpiece during machining;
acquiring machine information including at least one of a name, an axis configuration, and component part information of the machine tool, and attaching position information of the sensor;
acquiring gripping tool information including at least one of a name, a dimension, and a material of a gripping tool that grips the tool or the workpiece, and a gripping method of the tool or the workpiece;
acquiring at least one of tool information and workpiece information which are included in machined portion information, the tool information including at least one of a name, a dimension, and a material of the tool, the workpiece information including at least one of a name, a dimension, and a material of the workpiece;
acquiring a compensation factor representing a proportion between the first vibration characteristic and a second vibration characteristic based on at least one of the machine information, the gripping tool information, the tool information, and the workpiece information, the second vibration characteristic being based on an amount of vibration at the machining point when excitation force is applied to the machining point; and
estimating the second vibration characteristic by compensating the first vibration characteristic acquired in the acquiring of the first vibration characteristic using the compensation factor acquired in the acquiring of the compensation factor, wherein
the compensation factor is configured based on the machine information and a frequency linked to the machine information, and
the frequency is obtained from the sensor.
